(19) United States
(12) Patent Application Publication
(10) Pub. No.: US 2006/0127547 A1
(43) Pub. Date: Jun. 15, 2006

(54) Combined use of glycine and/or glycine derivatives and lactate and/or (di)acetate as antibacterial agent against Listeria in foods and/or drinks

(75) Inventors: Edwin E. W. Bontenbal, Wageningen (NL); Theo Vegt De Bert, Rotterdam (NL)

Correspondence Address: OLIFF & BERRIDGE, PLC, P.O. BOX 19928, ALEXANDRIA, VA, 22320, US

(73) Assignee: PURAC BIOCHEM B.V., AA GORINCHEM (NL)

(21) Appl. No.: 11/212,623

(22) Filed: Aug. 29, 2005

Related U.S. Application Data
(60) Provisional application No. 60/604,713, filed on Aug. 27, 2004.

(51) Int. Cl. A23L 3/3463

(52) U.S. Cl. 426/335

(57) ABSTRACT

The invention relates to the combined use of glycine and/or glycine derivative and lactate and/or (di)acetate salts, as antibacterial agent against Listeria bacteria in food and drink products.

This invention relates to the use of an antibacterial agent combination against Listeria bacteria, and in particular against Listeria monocytogenes in foods and drinks. Said antibacterial agent is in particular applied in refrigerated foods and drinks and more in particular in fresh or cooked meat (including poultry and fish) products.

Conventionally, bacterial growth in food and drink applications is controlled and/or prevented by means of pH regulation, water activity control, refrigeration, addition of quality preserving agents as e.g. nitrite and/or using various processing techniques as for example heat treatment, irradiation or high-pressure treatment. However, when controlling Listeria the above-described measures are often either insufficient, undesirable or not suitable for the type of food or drink product.

Listeria bacteria often end up in food and drink products due to contamination. Listeria is commonly present and it can grow at low temperatures. It is relatively insensitive to refrigeration temperatures. It is thus very difficult to prevent contamination of products and in particular of meat products. Further, Listeria is relatively insensitive to nitrite and pH regulation. The optimal pH for growth of Listeria is about 6, which is about the common pH in fresh or cooked meat. Further pH reduction would negatively affect the taste and texture of said meat products.

Accordingly, the preservation from Listeria of protein-containing food products, pH sensitive food products and refrigerated food products such as drinks and dairy products, salads and other vegetable products, dried foods and convenient foods as e.g. ready-to-eat meals, and especially meat (=including fish and poultry) products still proves to be a problem. It is known that one of the most important causes of food poisoning is contamination due to incorrect handling of food and drink products.

The invention provides a solution to the above-mentioned problems in preservation of foods and drinks against Listeria.

Various publications exist which describe the antibacterial effect of glycine against food spoilage: JP2000-224976 describes a preservative for food using calcium lactate and glycine in combination with organic acid salts such as e.g. citric acid, acetic acid or gluconic acid. Further, the publication describes that said preservative has effect against microorganisms such as lactic acid bacteria.

JP2001-245644 describes a method of improving a preservable period of a processed food such as processed meats or edible daily dishes by using at least a lactic acid salt and an acetic acid salt. Glycine may be added as necessary. The publication describes that said method is capable of suppressing the growth of microorganisms associated with putrefaction or deterioration.

UK 1510942 describes the concurrent use of maltose and glycine to prevent putrefaction in foodstuffs such as Japanese-style confectionaries, jams, jellies, chilled-served desserts, dairy products and fruit preserves. One test is described wherein said combination of maltose and glycine is tested against putrefaction of a beef extract medium by Bacillus bacteria.

U.S. Pat. No. 2,711,976 describes that glycine can be used against food spoilage by “heat resistant indigenous or natural flora which survive the usual cooking or heat treating operation” and further against food poisoning outbreaks by enterotoxigenic microorganisms such as Micrococcus pyogenes or more commonly referred to as Staphylococcus.

Some publications were found which describe the antibacterial effect of glycine, but its is not clear from the publication which bacteria were fought:

JP 08-154640 A discloses the use of an antimicrobial agent in foods to improve preservation wherein said agent contains 1-30 wt % acetic acid, with preferably 1-30 wt % of glycine and preferably 0.05-1 wt % of baked calcium. Gyoza (meat dumplings) and Harumaki (egg dough wrapped around minced vegetables, meat etc. in a small roll and fried in deep fat) are disclosed as food applications in which said antibacterial agent is used. The publication does not refer to specific bacteria against which said agent is effective.

JP 03 290174 A describes incorporating an unheated or low-temperature heat-treated food with glycine and further an organic acid such as acetic acid, adjusted to pH 5.5. or less and that is consequently put into a container to be subjected to high-pressure treatment by an aqueous pressure medium for sterilisation. The publication does not refer to food pathogenic bacteria against which glycine is effective. The publication does not refer to specific food and/or drink applications in which glycine is tested.

Another publication describes the use of glycine against molds and yeast and coliform: International Food Information, XP002315132, Hozova et al., “Prolonging the storage life of foods by non-traditional preservation methods”, Slovak. Inst. Of Tech., Czechoslovakia, 1989; This article describes the effect of glycine on prolonging the storage life of preserved products. Pork goulash was used as test product. All samples were processed by heat-treatment. The results show that addition of glycine has an effect on the growth of moulds and yeasts that are present in raw pork that has subsequently been heat-treated and pasteurised. The part of the microorganisms involving coliform microorganisms and arerobic spore-forming microorganisms is not significantly influenced by the presence of glycine.

The present invention is directed to the use of an antibacterial agent combination against Listeria, more preferably against Listeria monocytogenes, in foods and/or drinks wherein the antibacterial agent combination comprises:

glycine and/or glycine derivative, and

lactate and/or (di)acetate salt.

We have found that with the antibacterial agent combination according to the invention Listeria can effectively be controlled. While the sole use of glycine has proven to be uneffective against Listeria and the sole use of lactate and or (di)acetate also fails to give the desired effect, the present combination gives the desired effect.

Suitable lactate salts are potassium and sodium lactate. Suitable (di) acetate salts are potassium and sodium (di)acetate.

With glycine derivative is meant any compound which comprises glycine or glycinate. Examples of suitable glycine derivatives are (earth) alkali salts of glycine, ammonium glycinate, di- and tripeptides comprising glycine and esters of glycine and C1-C8 alcohols. With esters of glycine and C1-C8 alcohols is meant: esters of glycine and alcohols containing 1 up to 8 carbon atoms. Said carbon atom chains may be branched or straight. Examples of alkali glycinates are sodium glycinate and potassium glycinate; examples of earth alkali glycinates are magnesium glycinate and calcium glycinate; examples of glycinate esters of C1-C8 alcohols are methyl glycinate, ethyl glycinate, buthyl glycinate and hexyl glycinate.

The antibacterial agent combination according to the invention may suitably be used as the sole antibacterial agent in food and/or drink products.

The antibacterial agent combination according to the invention may very well be applied as antibacterial agent against Listeria in non-refrigerated products as for example soups, noodles, creams and some sausages and (powdered) dried products.

We have found further that the antibacterial agent combination according to the invention can suitably be used in refrigerated food and drink products. Refrigerated food and drink products are considered those food and drink products which require being kept at lowered temperature to increase the microbial stability before (preparation for) consumption. This is usually at a temperature between 4 and 7° C. with occasional peaks to 12° C. The use of the antibacterial agent combination according to the invention has specific advantages in refrigerated products, because listeria bacteria are known to be relatively insensitive to refrigeration. Examples of such refrigerated products are meat products (cured and/or uncured, fresh and/or cooked), salads and other vegetable products, drinks and dairy products, semi-processed foods, convenient foods as e.g. ready-to-eat meals and dried food products.

The antibacterial agent combination according to the invention is found to be very effective as antibacterial agent in meat applications including fish and poultry, both cured and uncured meat and fresh meat. The antibacterial agent combination according to the invention is found to be effective against said Listeria bacteria without loss of taste and without loss of texture.

Examples of fresh meat are beef, beef steak, beef oxtails, neckbones, short ribs, beef roasts, stew meat, beef briskets, pork, pork chops, pork steaks, cutlets, pork roasts, lamb, veal, game goat, filet americain, steak tartar, sushi, or carpaccio, chicken, turkey, duck and other poultry. Some of these fresh meat applications are to be consumed raw, while others are consumed after application of only partial heat treatment, intentionally applied as e.g. for medium cooked steak or unintentionally applied due to improper preparation or improper handling of the food products. The use of the antibacterial agent combination according to the invention ensures food safety even in the case of partial heat-treatment.

Glycine concentrations of 0.5 to 3 wt % based on total weight of product were found to be effective as antibacterial agent for Listeria bacteria and glycine concentrations of 0.5 to 1.5 wt % based on total weight of product were found to be suited in ensuring taste of the product.

Tests showed that a concentration of about 1 to 1.5 wt % of glycine based on total weight of product starts to affect the taste of said product. In said product no auxiliary antibacterial agents and no other taste affecting ingredients were present. A glycine concentration above 1.5 wt % based on total weight of the product gives the product a sweet taste. Dependent on the type of product this sweet taste is acceptable or not. In sweet drinks for example the sweetening effect of glycine is not considered a problem. Accordingly the maximally acceptable glycine concentration in terms of not negatively affecting taste can be increased to concentrations above 1.5 wt % glycine based on total weight of the product. Further, dependent on the presence of other taste affecting ingredients in the product as for example masking agents, the maximum concentration of glycine and/or (earth)alkali glycinate salts, ammonium glycinate and/or esters of glycine and C1-C8 alcohols can also be increased up to a point at which the taste starts to be negatively affected by the presence of glycine and/or said glycine derivative.

It was found that lactic acid and/or ( di) acetate may be present in concentrations of 0.2 to 3 wt % by weight based on said foods and drinks.

In some cases it is advantageous to combine the use of the antibacterial agent combination according to the invention with one or more of the earlier mentioned processing techniques for preservation as e.g. heat treatment, irradiation and/or high-pressure treatment.

The present invention is further illustrated by the following examples, which are not to be construed as being limitative.

### EXAMPLES

### Example 1

Batches of completely cooked sausage without nitrite were prepared according methods known to the person skilled in the art. The basic composition of the cooked sausage consisted of 7% beef (10% fat), 10.2% pork (8% fat), 69% bacon (40% fat), 9.00% water/ice (−2 degrees Celsius), 2.0 % sodium chloride salt, 0.35% spices, 0.35% phosphate, 0.05% sodium ascorbate, 0.05% sodium glutamate and 2.00% wheat starch (percentages all by weight of total product). After addition of the above-mentioned ingredients except for the starch, the sausage was homogenised for several minutes and divided in several portions. The starch was added together with the following additives to different portions of sausage:
1.8% potassium lactate (by weight of total product)
1.8% potassium lactate +0.5% glycine (both by weight of total product)
1.68% potassium lactate +0.12% sodium di-acetate +0.5% glycine (all by weight of total product)

The cooked sausage portions were inoculated with Listeria monocytogenes, type 4a (ATCC 19114). The sausage was placed in the bowl of a disinfected laboratory cutter (Scharf®), cut into small pieces and inoculated with a suspension of mentioned bacteria to a final level of about 10³ per g product each. After inoculation, the sausages were minced and homogenised for 2 minutes. Subsequently the minced product was divided into portions of 40 g and vacuum packaged in plastic pouches with an oxygen permeability of less than 5.0×⁻¹¹ m³.m².Pa⁻¹.day⁻¹ at 20 degrees Celsius.

The packages obtained were stored at 12 degrees Celsius for up to 12 days. During the experiment the temperatures were registered using a Temptimem® data logger.

At appropriate time intervals, samples of minced cooked sausage were taken in duplicate for microbiological analyses. From each single package a sample of 20 g was taken aseptically, diluted 10-fold in physiological peptone saline (PPS) and homogenised in a stomacher for 1 minute. Additional serial dilutions were made in PPS. Numbers of Listeria were determined using Palcam agar (Oxoid®) CM877 and SR150). Plates were incubated at 37 degrees Celsius for 2 days.

TABLE I shows the results (in duplicate) of the microbiological analyses of vacuum packed cooked sausage inoculated with Listeria monocytogenes and with glycine added in combination with salts of lactic acid and acetic acid during storage at 12 degrees Celsius.

TABLE I
Results of Listeria count on vacuum packed cooked sausages with
different additives during storage at 12 degrees Celsius.

| | Bacterial counts in log cfu per g | | | | |
|---|---|---|---|---|---|
| | of product after storage during | | | | |
| Additive | 0 days | 3 days | 5 days | 7 days | 12 days |
| Control | 2.80 | 5.09 | 7.04 | 8.52 | 8.88 |
| (no additive) | 2.72 | 4.98 | 7.03 | 8.72 | 8.74 |
| 1.8 wt % | 2.71 | 2.78 | 2.95 | 4.01 | 5.95 |
| Potassium lactate | 2.70 | 2.70 | 2.92 | 4.20 | 5.98 |
| 1.8 wt % | 2.70 | 2.77 | 2.75 | 2.20 | 2.58 |
| potassium lactate + | 2.83 | 2.66 | 2.65 | 2.26 | 2.66 |
| 0.5 wt % glycine | | | | | |
| 1.69 wt % | 2.66 | 2.59 | 2.67 | 1.48 | 1.00 |
| potassium lactate + | 2.63 | 2.70 | 2.72 | 2.08 | 1.70 |
| 0.12 wt % | | | | | |
| sodium di-acetate + | | | | | |
| 0.5 wt % glycine | | | | | |

The results show that glycine used in combination with lactate and/or (di)acetate has an antibacterial effect.

### Example 2

Batches consisting of three cooked sausages, circa 500 g each, were prepared.

The basic composition of the cooked sausage is given below:

Basic composition cooked sausage

| Ingredient | % |
|---|---|
| Beef (20% fat) | 7.00 |
| Lean Pork (8% fat) | 10.20 |
| Bacon (30% fat) | 69.00 |
| Water/ice | 9.00 |
| Colorozo (salt with 0.6% nitrite) | 2.00 |
| Spices | 0.35 |
| Sodium tri-poly phosphate | 0.35 |
| Sodium ascorbate | 0.05 |
| Sodium glutamate | 0.05 |
| Wheat starch | 2.00 |

Each cooked sausage was inoculated with a cocktail of three types of Listeria monocytogenes: type 1/2a (ATCC 35152), type 4a (ATCC 19114) and type 4b (ATCC13932). Before inoculation the cultures, kept on slants, were precultivated twice in Brain Heart Infusion broth (BHI, Oxoid® CM225) for 24 hours at 30° C. The full grown cultures were diluted in physiological peptone saline (PPS) to obtain a mixture at the desired level.

Two sausages (ca. 1000 g) of each composition were placed in the bowl of a disinfected laboratory cutter (Scharf®), cut into small pieces and inoculated with 10 ml of a suspension of mentioned bacteria to a final level of about 10² per g product. After inoculation, the sausages were minced and homogenised for 2 minutes. Subsequently, the minced product was divided into 20 portions of 40 g and vacuum packaged in plastic pouches with an oxygen permeability of less than 5.0×10⁻¹¹ m³. m⁻². Pa⁻¹. day⁻¹ at 20° C. The packages obtained were stored at 4° C. for up to 60 days. During the experiment the temperatures were registered using a data logger.

At appropriate time intervals, samples of minced cooked sausage of each batch were taken in duplicate for microbiological analyses. From each single package a sample of 20 g was taken aseptically, diluted 10-fold in PPS and homogenised in a stomacher for 1 minute. Additional serial dilutions were made in PPS. Numbers of L. monocytogenes were determined using Palcam agar (Oxoid® CM877 and SR1 50) as mentioned in ISO 1 1290-2: 1998. Plates were incubated at 37° C. for 2 days.

The results of the microbiological analyses of the cooked sausages with different additives during vacuum packed storage at 4° C. are given in Table II

TABLE II
Results of L. monocytogenes counts on vacuum packed cooked sausages
with different additives during storage at 4° C.

| | Bacterial counts in log cfu per g of product after storage during | | | | | | |
|---|---|---|---|---|---|---|---|
| Additive | 0 days | 7 days | 12 days | 18 days | 27 days | 41 days | 60 days |
| Control (no additive) | 2.32 | 2.34 | 2.78 | 3.52 | 4.51 | 6.74 | 8.81 |
| | 2.20 | 2.49 | 2.77 | 3.69 | 4.77 | 6.53 | 8.72 |
| 0.5 wt % glycine | 2.36 | 2.45 | 2.52 | 3.10 | 4.20 | 6.40 | 8.15 |
| | 2.28 | 2.43 | 2.63 | 2.98 | 4.36 | 6.45 | 8.15 |
| 0.1 wt % glycine | 2.41 | 2.36 | 2.45 | 3.52 | 3.86 | 5.94 | 8.09 |
| | 2.40 | 2.15 | 2.15 | 3.73 | 3.94 | 5.88 | 7.66 |
| 1.04 wt % sodium lactate | 2.34 | 2.08 | 2.32 | 2.41 | 2.41 | 2.87 | 3.49 |
| | 2.38 | 2.20 | 2.11 | 2.30 | 2.04 | 2.41 | 3.38 |
| 1.04 wt % sodium lactate + | 2.18 | 1.85 | 2.40 | 2.23 | 2.45 | 2.65 | 5.33 |
| 0.5 wt % glycine | 2.41 | 2.18 | 2.18 | 2.40 | (4.04) | 2.68 | 4.99 |
| 1.04 wt % sodium lactate + | 2.08 | 2.04 | 2.26 | 2.83 | 2.36 | 3.36 | 4.49 |
| 1.0 wt % glycine | 1.85 | 1.30 | 2.26 | 2.38 | 2.15 | 2.96 | 5.05 |

These experiments show that the sole addition of glycine does not inhibit Listeria growth while the combined addition of glycine and lactate and/or (di) actetate does.

### Example 3

Batches consisting of three cooked sausages, circa 500 g each, were prepared. The basic composition of the cooked sausage is given below

Basic composition cooked sausage

| Ingredient | % |
|---|---|
| Beef (10% fat) | 7.00 |
| Pork (8% fat) | 10.20 |
| Bacon (40% fat) | 69.00 |
| Water/ice | 9.00 |
| Colorozo | 2.00 |
| Spices | 0.35 |
| Phosphate | 0.35 |
| Sodium ascorbate | 0.05 |
| Sodium glutamate | 0.05 |
| Wheat starch | 2.00 |

The sausages were stored for 1 day at 0° C. until further examination. Each cooked sausage was inoculated with Listeria monocytogenes, type 4a (ATCC 19114). Two sausages were placed in the bowl of a disinfected laboratory cutter (Scharf®), cut into small pieces and inoculated with a suspension of mentioned bacteria to a final level of about 10² and 10⁴ per g product respectively. After inoculation, the sausages were minced and homogenised for 2 minutes. Subsequently, the minced product was divided into 20 portions of 40 g and vacuum packaged in plastic pouches with an oxygen permeability of less than 5.0×10⁻¹¹ m3. m-2. Pa-1. day-1 at 20° C. The packages obtained were stored at 7° C. for up to 21 days. During the experiment the temperatures were registered using a data logger.

At appropriate time intervals, samples of minced cooked sausage of each batch were taken in duplicate for microbiological analyses. From each single package a sample of 20 g was taken aseptically, diluted 10-fold in physiological peptone saline (PPS) and homogenised in a stomacher for 1 minute. Additional serial dilutions were made in PPS. Numbers of L. monocytogenes were determined using Palcam agar (Oxoid® CM877 and SR150). Plates were incubated at 37° C. for 2 days.

The results of the microbiological analyses of the cooked sausages with different additives during vacuum packed storage at 7° C. are given in Table III

TABLE III
Results of L. monocytogenes counts on vacuum packed cooked sausages
with different additives during storage at 7° C.

| | Bacterial counts in log cfu per g of product after storage during | | | | | | |
|---|---|---|---|---|---|---|---|
| Additive | 0 days | 4 days | 7 days | 10 days | 14 days | 17 days | 21 days |
| Control (no additive) | 4.71 | 4.79 | 5.30 | 6.17 | 7.36 | 6.26 | 6.72 |
| | 4.64 | 4.84 | 5.18 | 6.21 | 7.19 | 6.90 | 7.17 |
| 0.5 wt % glycine | 4.53 | 4.78 | 5.28 | 5.75 | 7.18 | 6.91 | 7.21 |
| | 4.49 | 4.73 | 5.12 | 6.12 | 6.86 | 7.00 | 7.01 |
| 1.0 wt % glycine | 4.59 | 4.81 | 4.93 | 5.72 | 6.40 | 6.66 | 7.45 |
| | 4.53 | 4.69 | 4.88 | 5.56 | 6.52 | 6.71 | 7.54 |
| 3.0 wt % potassium lactate | 4.63 | 4.81 | 4.60 | 4.57 | 4.66 | 4.41 | 4.60 |
| | 4.52 | 4.66 | 4.59 | 4.69 | 4.74 | 4.58 | 4.63 |
| 3.0 wt % potassium lactate/ | 4.36 | 4.66 | 4.59 | 4.78 | 4.69 | 4.63 | 4.62 |
| sodium diacetate (14:1) | 4.46 | 4.61 | 4.78 | 4.70 | 4.74 | 4.43 | 4.51 |
| 3.0 wt % potassium lactate + | 4.56 | 4.58 | 4.69 | 4.68 | 4.49 | 4.51 | 4.74 |
| 0.5 wt % glycine | 4.60 | 4.54 | 4.62 | 4.72 | 4.57 | 4.32 | 4.65 |
| 3.0 wt % potassium/sodium | 4.45 | 4.43 | 4.67 | 4.62 | 4.40 | 4.51 | 4.61 |
| di-acetate (14:1) + | 4.54 | 4.73 | 4.41 | 4.72 | 4.56 | 4.56 | 4.56 |
| 0.5 wt % glycine | | | | | | | |

1-10. (canceled)

11. A method of controlling or preventing Listeria growth in a food or drink product, comprising applying an antibacterial agent combination to the food or drink product, wherein the antibacterial agent combination comprises:
at least one of glycine and a glycine derivative; and
at least one of a lactate salt and a (di)acetate salt.

12. The method of claim 11, wherein the antibacterial agent combination comprises at least one lactate salt selected from the group consisting of sodium lactate and potassium lactate.

13. The method of claim 11, wherein the antibacterial agent combination comprises at least one (di)acetate salt selected from the group consisting of sodium (di)acetate and potassium (di)acetate.

14. The method of claim 11, wherein the antibacterial agent combination comprises at least one glycine derivative selected from the group consisting of alkali earth glycinate salts, ammonium glycinates, dipeptides comprising glycine, tripeptides comprising glycine, and esters of glycine and C1-C8 alcohols.

15. The method of claim 11, wherein the antibacterial agent combination is the only antibacterial agent applied to the food or drink product.

16. The method of claim 11, comprising applying the antibacterial agent combination to a food or drink product that is subject to refrigeration.

17. The method of claim 11, comprising applying the antibacterial agent combination to meat.

18. The method of claim 1, comprising applying the antibacterial agent combination to fresh meat.

19. The method of claim 11, wherein the at least one of glycine and a glycine derivative is applied in an amount of from 0.5 to 3 weight percent based on a total weight of the food or drink product.

20. The method of claim 1 1, wherein the at least one of glycine and a glycine derivative is applied in an amount of from 0.5 to 1.5 weight percent based on a total weight of the food or drink product.

21. The method of claim 11, wherein the at least one of a lactate salt and a (di)acetate salt is applied in an amount of from 0.5 to 3 weight percent based on a total weight of the food or drink product.
